(19) United States
(12) Patent Application Publication
(10) Pub. No.: US 2020/0207574 A1
(43) Pub. Date: Jul. 2, 2020

(54) STATUS CHECKING OF FIELD DEVICES OF A BUILDING-ASSOCIATED INSTALLATION FOR TRANSPORTING PEOPLE

(71) Applicant: Inventio AG, Hergiswil (CH)

(72) Inventors: Axel Hosemann, Auw (CH); Thomas Hartmann, Kleinwangen (CH)

(21) Appl. No.: 16/639,773

(22) PCT Filed: Sep. 11, 2018
(86) PCT No.: PCT/EP2018/074355

§ 371 Date: Feb. 18, 2020

(30) Foreign Application Priority Data
Sep. 13, 2017 (EP) 17190951.8

(51) Int. Cl. B66B 1/34; B66B 1/24; B66B 5/00; B66B 3/00; H04L 12/403

(52) U.S. Cl. CPC B66B 1/3461; B66B 1/24; B66B 5/0031; G05B 19/045; B66B 5/0018; H04L 12/403; B66B 3/002

(57) ABSTRACT

A method for checking the status of field devices of a building-associated installation for transporting people includes the steps of: sending a command block of a status telegram from a monitoring unit via a series bus to a plurality of field devices; supplementing the status telegram by the field devices that are addressed by the command block; receiving the data block supplemented by the addressed field devices by the monitoring unit; and evaluating the status values in the supplemented data block by the monitoring unit.

### FIELD

The present invention relates to a method for checking the status of field devices of a building-based passenger transport system, as well as a communication system that carries out this method.

### BACKGROUND

Building-based passenger transport systems, such as elevators, escalators and moving walkways, are used to transport persons within buildings. Elevator systems are used, for example, to make it possible to transport passengers between different floors within a building. For this purpose, in general an elevator car can be moved inside a usually vertical elevator shaft. When the elevator car has reached a desired floor, an elevator door, and optionally together therewith an associated door on the floor, can be opened in order to allow passengers to access the elevator car and/or to leave the elevator car.

Functions of the elevator system, such as actuation of the drive thereof that moves the elevator car, are usually controlled by a central control unit. In the process, the central control unit can for example take into account information that it can obtain by processing sensor signals. The sensor signals may in particular originate from devices such as door switches or other safety switches that are distributed around the building which accommodates the elevator system. Devices of this kind are referred to as field devices in the following.

In particular, the control unit may perform safety functions which, when one of the sensors emits a safety-related status message, generate an alarm which, for example, blocks other functions of the control unit. For example, the drive of the control unit can no longer be activated if a door sensor signals that an elevator door is not closed. The corresponding components of the control unit can be understood to be a monitoring module or the control unit can be understood to be a monitoring unit.

The field devices and the central control unit are generally connected via a data bus, via which these status messages can be exchanged.

EP 2 251 293 A1 describes, for example, a conventional elevator control apparatus comprising a field bus interface.

Encoding of data values with the special (7,4) Hamming encoding is described for example in “https://en.wikipedia.org/wiki/Hamming(7,4)”.

Since status messages from the field devices should be evaluated as quickly as possible by a monitoring unit using safety-relevant sensor data, for example, there may be a need to transmit these status messages as quickly as possible and in an error-free manner from the field devices to the monitoring unit.

### SUMMARY

One aspect of the invention relates to a method for checking the status of field devices of a building-based passenger transport system. The field devices are usually connected to safety sensors. On one hand, the status of a field device should be understood to mean the status of the field device itself, i.e. whether or not the field device is ready for operation. On the other hand, it should also be understood to mean the status of safety sensors connected to the field device, i.e. whether a safety switch is open or closed, for example. As already mentioned, a building-based passenger transport system may be an elevator system, an escalator system or a moving walkway system. Safety sensors may generally be any type of sensor that detects safety-related information about components of the building-based passenger transport system. Examples of such sensors are door-closing sensors which detect whether an elevator door is properly closed.

The method may, for example, be carried out automatically by a monitoring unit of the building-based passenger transport system together with various field devices, which are interconnected by a data bus.

According to an embodiment of the invention, the method comprises: transmitting a command block of a status telegram from a monitoring unit via a serial bus to a plurality of field devices; supplementing a data block of said status telegram with status values by means of field devices addressed by the command block; receiving the supplemented data block by means of the monitoring unit; and evaluating the status values by means of the monitoring unit. In the process, said field devices supplement the data block of the single status telegram, which is transmitted by the monitoring unit in a single status check, i.e. at a specific time.

A telegram can be considered to be a bit sequence having a defined structure, which is transmitted over the serial bus within a closed time window. In the process, the same time unit can be provided for each bit. The command block may be a predetermined number of bits at the start of the status telegram. The data block may be the remaining bits.

Each of the field devices arranged serially, i.e. one after another in series, can generate a status value, for example a number, by querying sensors connected thereto and evaluating the measurement results therefrom. For example, a plurality of sensors can be connected to one field device, for each of which a sensor-specific status value, such as “OK” or “alarm,” is generated. Such sensors may be door switches and/or safety switches, for example. The sensor-specific status values can be combined to form the field-device-specific status value. The status value can be generated independently of the arrival of the status telegram by the field device and/or can be stored therein. For example, a status value may include 4 bits, each set to 1, if the corresponding safety sensor signals a hazard (such as door open).

In the simplest case, the status value can also only indicate whether the relevant field device is still functional. In this case, for example, it can transmit a fixed status value. It is also possible for the status value indicating the functionality to change according to a predetermined rule, for example the status value increases by 1 for each query.

If the monitoring unit then starts to transmit the status telegram and the field devices connected to the serial bus have evaluated the command block, they can determine whether they are prompted to identify their status value to the monitoring unit. Which field devices are addressed can be encoded in the command block. However, it may also be the case that, for example with a correspondingly low number of field devices, each field device is addressed when the command block of a status telegram is received.

Each of the addressed field devices is assigned a position in the data block, and at the time at which this position in the data block is to be modulated on the serial bus, this is carried out by the corresponding field device. In a single status check, the field devices thus all modulate the same status telegram in succession. The monitoring unit and the individual field devices thus transmit virtually simultaneously. The data block generated by the addressed field devices can then be immediately read out and evaluated by the monitoring unit.

Since the field devices do not wait for the status telegram to be completely transmitted as a pure command telegram and subsequently do not transmit their status values in further response telegrams, the status values can be queried considerably more rapidly. Only one status telegram, which is initiated by the monitoring unit, needs to be completed by the addressed field devices. The data block of the status telegram can be evaluated promptly by the monitoring unit without new telegrams having to be initiated by the field devices. The status information from the field devices can be integrated into a single status telegram which can be read and received simultaneously by all bus users, i.e. field devices and monitoring unit.

The data block can now be supplemented by the field devices by each field device connected to the serial bus (if it is even configured to generate a safety-relevant status value) carrying out the following steps: receiving the command block by means of a field device; determining a status end position in a data block of the status telegram adjoining the command block by means of an addressed field device; and transmitting a status value of the addressed field device to the monitoring unit via the serial bus when the status end position in the data block is reached, the status value encoding the status of one or more safety sensors connected to the field device. In the process, each field device addressed by the command block is assigned an individual status end position which defines a region assigned to the relevant field device in the data block of the status telegram. The status end positions are set such that the individual regions of the field devices do not overlap.

Data packets or telegrams can be transmitted via the serial bus by transmitting individual bits of the telegram via the bus in chronological order. For example, for the bit value 0, the bus may be connected to the earth, resulting in a voltage of 0 V on the bus conductor. A bit value of 1 can be transmitted by an open (not earthed) bus, for example having 24 V. The monitoring unit always transmits the bit value 1 in the data block, which is modulated by an addressed field device at the positions intended therefor, i.e. can be changed into the bit value 0. The unit of time during which a bit is transmitted may be constant. The bits can be transmitted in particular in so-called frames with a start and stop bit. This can be used to calculate when a specific bit of a telegram is transmitted via the bus, namely the start time of the telegram plus the number of the bit in the telegram multiplied by the length of the time unit.

The position in the data block at which a field device starts to transmit its status value may be fixed or may be determined on the basis of the command block. For example, the data block comprises a plurality of equally long status words, in each of which a status value is encoded. The status end position can be determined by multiplying the number of the field device in the data block by the length of a status word.

According to an embodiment of the invention, the command block encodes a command value that identifies the start of a status telegram. The command value may be a fixed-length bit sequence at the start of each telegram. For example, other command values may identify other types of telegrams, such as control commands for the field devices that can actuate not only sensors but also actuators.

According to an embodiment of the invention, status telegrams are identified by two different command values. It is possible for there to be different types of status telegram, which may for example be encoded differently.

According to an embodiment of the invention, the remaining bits of a status telegram having a first command value and/or the data block thereof are inverted relative to the bits of a corresponding status telegram having a second command value and the data block thereof having the same content. There may be two types of status telegram, in which the data bits or certain parts of the status telegram are inverted relative to each other.

For example, a command value may comprise 4 bits. For example, the two types of status telegram may have the command values that are encoded by the bit sequences representing the numbers 3 (i.e. the bit sequence 0011) and 12 (i.e. the bit sequence 1100). The bit sequence of one command value may also be inverted relative to the other command value.

According to an embodiment of the invention, the command block encodes destination addresses for field devices which determine which field devices are addressed by the status telegram. Each field device may have an address unique to the bus, for example a number that may be encoded by four bits or one byte. For example, the destination addresses of a status telegram may be encoded by two numbers representing the start and end of an interval of field device addresses. It is also possible for only the start of an interval of destination addresses to be present in the command block and for the interval to be determined on the basis of a predetermined length of the interval and/or the status telegram.

However, it is also possible for all the field devices connected to the bus to be addressed by the status telegram, for example by the command value alone. Destination addresses are then not necessary and/or the command block does not have to encode any destination addresses.

According to an embodiment of the invention, the command block encodes a telegram length. The telegram length can encode the length of the telegram in the data block in bits, bytes or a number of data values. Alternatively, an interval of destination addresses can be determined by the address of a first field device and a number of field devices following this field device in the address space. This number can be determined from the telegram length. It is possible that status telegrams can have different lengths.

According to an embodiment of the invention, the data block is divided into status words of the same bit length, which are assigned to the addressed field devices and in which the status value of the assigned field device is coded. The status end position may be the start of the status word assigned to the field device. The status values are encoded in the status words, either directly as numbers in binary format and/or also by means of encoding which can detect and/or eliminate an erroneous transmission over the serial bus. For example, a status word may also include one or more parity bits. Each status word may, for example, be one byte of the data block.

According to an embodiment of the invention, the method further comprises: generating an alarm if the status values received by the monitoring unit indicate a hazard detected by the security sensors connected to the field devices. For example, any status value not equal to 0 may indicate a safety issue (such as “door open”). In this case, the monitoring unit can stop other components of the building-based passenger transport system or prevent them from starting to operate.

According to an embodiment of the invention, the status values are encoded with error-indicating and/or error-correcting encoding. In this way, the monitoring unit can detect if the status values have been transmitted correctly over the serial bus. An exchange of confirmation telegrams can be omitted. Furthermore, a number of erroneously transmitted values can be reduced by error correction.

For example, the status values can be encoded using Hamming encoding. For example, the status value may contain four bits of information, which in turn are mapped to seven bits by means of the (7,4) Hamming code generator matrix. The seven-bit code words can be extended by an additional parity bit to achieve a minimum Hamming distance of 4. For a detailed description of the (7,4) Hamming code, see, for example, https://en.wikipedia.org/wiki/Hamming(7,4).

According to an embodiment of the invention, the method further comprises: Generating an alarm if the status values received and decoded by the monitoring unit indicate erroneous encoding by the transmitting field device. In addition to an alarm due to a detected safety issue, an alarm may also be generated due to a possibly faulty safety system. In the event of such an alarm, too, the monitoring unit can stop other components of the building-based passenger transport system or prevent them from starting to operate.

According to an embodiment of the invention, all field devices connected to the bus are addressed by a plurality of status telegrams, which are regularly transmitted in a cycle. In general, the status values can be queried regularly by the monitoring unit. If it is necessary that more than one status telegram needs to be used for the query, for example because of the number of field devices, the queries can take place cyclically.

For example, the field devices are divided into groups, which are each addressed by a status telegram from the cycle. In each cycle, all the groups of field devices can be queried. Each of these groups can comprise the same number of field devices. A status telegram can address in approximately 15 field devices at the same time. The number of field devices can be limited by the length of the data block of the status telegram.

According to an embodiment of the invention, status telegrams are generated regularly or generated at equal time intervals. In this way, the same status information can be queried repeatedly. If a plurality of status telegrams are present which have been supplemented by the same field devices, the monitoring unit can determine the bits of the data block of a status telegram by means of a majority formation of bit values of a plurality of status telegrams addressing the same field devices. Majority formation means that a bit is set to the value which occurs most frequently at the same position in the status telegrams to be considered. For example, the actual bit value may be the bit that occurs at least twice in three cycles at the position concerned.

According to an embodiment of the invention, the majority formation of bits of the data block and/or a status word takes place only if at least one status word which has been coded with error-indicating encoding indicates erroneous encoding. An error-free data block or status word can be further processed directly without majority formation.

According to an embodiment of the invention, status telegrams occupy the bus at a time interval and waiting periods are provided between the status telegrams. The bus does not have to be completely occupied with status telegrams, but there may be periods of time in which bus participants other than the monitoring unit can transmit telegrams. By way of example, a cycle of status telegrams which queries a plurality of groups of field devices may be formed by status telegrams between which there are waiting periods.

According to an embodiment of the invention, a field device, when it detects a status change in a connected safety sensor, begins transmitting a spontaneous telegram to the monitoring unit within a waiting period, which encodes the status change. An example of telegrams that can be transmitted independently by the field devices are spontaneous telegrams, which are transmitted to the monitoring unit independently of a request by said unit. In this way, a field device can report a security issue, although it would only be queried later in the cycle.

Telegrams transmitted by other bus participants, and in particular spontaneous telegrams, can be longer than the waiting periods. In this case, the monitoring unit can interrupt or postpone the query cycle until the telegram has been completely transmitted.

Another aspect of the invention relates to a communication system for a building-based passenger transport system comprising a plurality of field devices; a monitoring unit; and a serial bus to which the monitoring unit and the plurality of field devices are connected. The monitoring unit may be, for example, a central controller or a module of a central controller of the building-based passenger transport system. The communication system is further configured to carry out the method as described above and below.

According to an embodiment of the invention, each of the field devices comprises a synchronization module. The synchronization module is configured to receive the command block and to transmit the corresponding status word of a status telegram. Furthermore, the field device may comprise further components which, for example, can communicate with sensors, process sensor data and/or generate and/or process other telegrams. The synchronization module may, for example, be implemented in the form of a CPLD (complex programmable logic device), while further functions of the field device may be performed by a microcontroller.

The synchronization module may comprise a transceiver module for transmitting and receiving bit sequences via the bus, wherein the transceiver module is configured to recognize command blocks of a status telegram and to transmit status values within a status telegram.

Furthermore, the synchronization module may comprise a transmission position determination module which is configured to determine the status end position from a command block of a status telegram received with the transceiver module and to thus trigger the transceiver module to transmit the status value. The status value may already be stored in the synchronization module and/or does not have to be queried by other components of the field device.

Furthermore, the synchronization module may include a collision detection module configured to detect when another field device and/or the monitoring unit is already transmitting on the bus and to abort transmission by the synchronization module in this case.

Furthermore, the synchronization module may be configured to transmit a spontaneous telegram generated by the field device to the bus or to generate said telegram on the basis of a command from the field device itself. It may also be possible for the synchronization module to suppress or delay the transmission of spontaneous telegrams during a status telegram.

It should be noted that some of the possible features and advantages of the invention are described herein with reference to different embodiments. A person skilled in the art recognizes that the features can be combined, adapted or replaced as appropriate in order to arrive at further embodiments of the invention.

In the following, embodiments of the invention shall be described with reference to the accompanying drawings, with neither the drawings nor the description being intended to restrict the invention.

### DESCRIPTION OF THE DRAWINGS

FIG. 1 schematically shows a building-based passenger transport system in the form of an elevator system according to an embodiment of the invention.

FIG. 2 schematically shows a field device for a building-based passenger transport system according to an embodiment of the invention.

FIG. 3 shows a flow chart for a method for checking the status of field devices of a building-based passenger transport system according to an embodiment of the invention.

FIG. 4 is a diagram of a status telegram for the method from FIG. 3.

FIG. 5 is a diagram of a telegram cycle for the method from FIG. 3.

The drawings are merely schematic and not to scale. In the different figures, identical reference signs denote identical or similar features.

### DETAILED DESCRIPTION

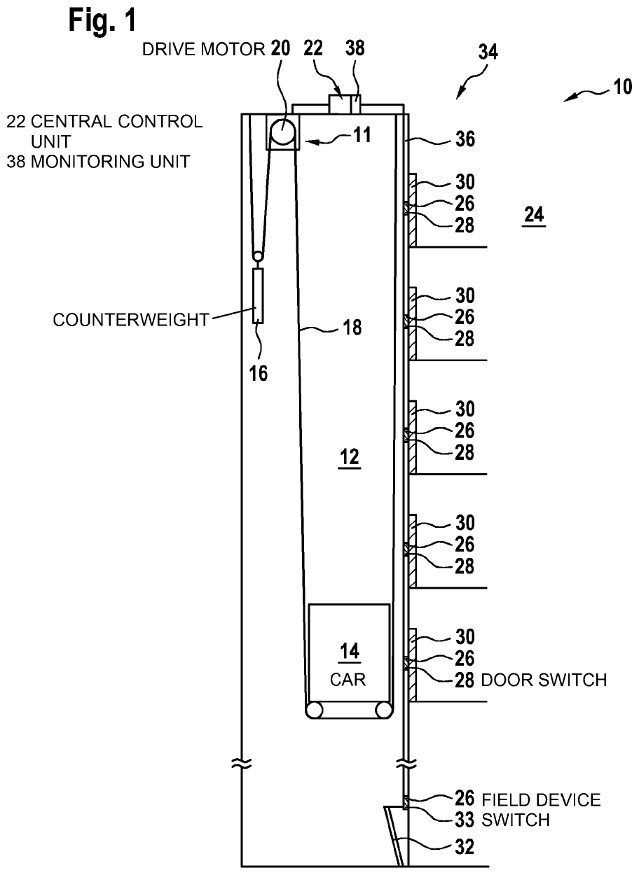

FIG. 1 shows a building-based passenger transport system 10 in the form of an elevator system 10. An elevator system will be described below by way of example. However, it should be understood that other passenger conveyors 10, such as escalators or moving walkways, may comprise such communication systems, monitoring units, field devices, and sensors as described below.

The elevator system 10 comprises an elevator shaft 12, in which an elevator car 14 and a counterweight 16 can be moved. For this purpose, the elevator car 14 and the counterweight 16 are suspended on a cable-like or belt-like suspension means 18, which can be moved by a drive motor 20. The operation of the elevator system 10 and in particular the drive motor 20 can be controlled using a central control unit 22.

In order to be able to ensure correct functioning and in particular safety of the elevator system 10, a plurality of field devices 26 are accommodated in a structure 24 that accommodates the elevator system 10. In this case, the field devices 26 are distributed over the structure 24. The field devices 26 may, for example, comprise a door switch 28 or be connected to a door switch 28, which can monitor a closure state of doors 30, in particular of doors on a floor, of the elevator system 10. The door switches 28 may be considered to be safety sensors. Furthermore, a ladder 32 may be mounted close to a floor or a pit of the elevator shaft 12, for example, the correct, neat positioning of which ladder on a side wall of the elevator shaft 12 is monitored, for example, by means of a switch 33 connected to a field device 26. The switch 33 may also be considered to be a safety sensor. The field devices 26 may be part of a communication system 34 of the elevator system 10 and may be connected to the central control unit 22 or in particular to a monitoring unit 38 integrated there for example, by means of a serial bus 36, for example. The field devices 26 are arranged in series one behind the other, with two field devices 26 arranged one behind the other being connected to the serial bus 36 in each case.

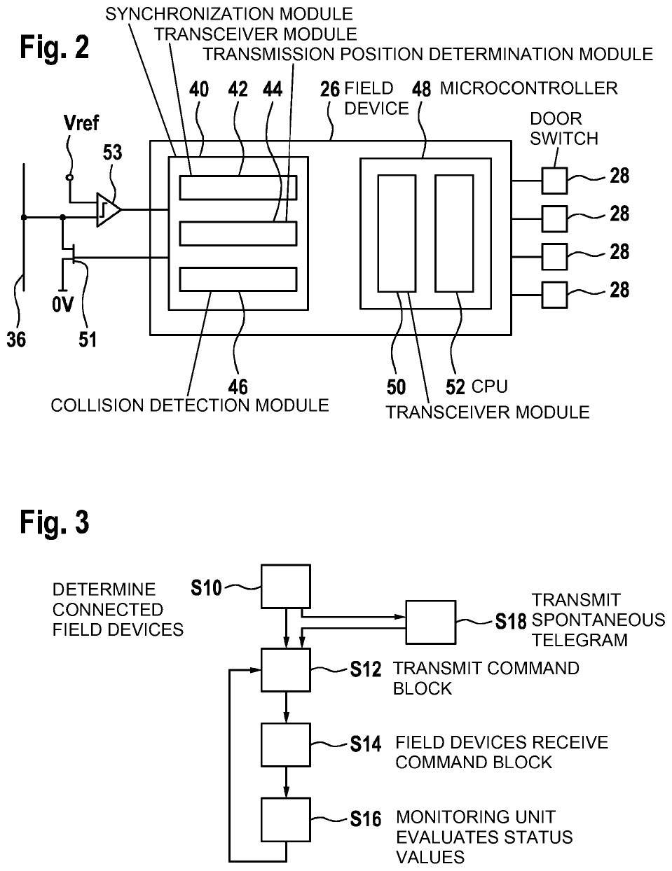

FIG. 2 shows a field device 26. The field device 26 is set up to output sensor signals generated by one or more sensors 28 and/or to receive control signals to be implemented by one or more actuators. In this case, the field device 26 itself may for example comprise one or more sensors 28 and/or one or more actuators. The field device 26 may output the sensor signals generated by the sensor to other field devices 26, in particular to the central control unit 22 or the monitoring unit 38, via the serial bus 36, or may convey control signals received from other devices, in particular the central control unit 22, to an actuator via said bus 36, such that said actuator can implement the control commands contained therein. Alternatively or additionally, a field device 26 may function as a node that can, for example, receive sensor signals from an external sensor and/or from another field device 26 and then output said signals to further devices, or that can receive control signals from further devices and then forward said signals to an external actuator, such that said actuator implements the control signals.

FIG. 2 shows that the field device 26 may comprise a synchronization module 40, which in turn may be divided into a transceiver module 42, a transmission position determination module 44 and a collision detection module 46. The functions of the modules 42, 44, 46 will be described in greater detail with reference to the following figure, FIG. 3. For example, the synchronization module 40 may be implemented as a CPLD (complex programmable logic device) to implement the functions at high speed.

The field device may further comprise a microcontroller 48, which may include its own transceiver module 50 and a CPU 52 (central processing unit). The transceiver module 50 and/or the transceiver module 42 may be configured as a UART (universal asynchronous receiver transmitter).

Furthermore, FIG. 2 shows that the serial bus 36 can be connected to earth (0 V) by the transceiver module 42 by means of a transistor 51, in order to transmit the bit “0” on the bus 36. If the bus 36 is not earthed by any of the bus participants, then the bit “1” is transmitted. Furthermore, the transceiver module 42 is supplied with the current value of the bus in the form of a signal derived from a comparator 53, which compares the voltage on the bus 36 with a reference signal Vref.

It should be noted that “transmitting” on the serial bus 36 means that the relevant bus participant (such as the monitoring unit 38 or a field device 26) places bits “0” and “1” on the bus 36, as just described. Conversely, “receiving” means that the relevant bus participant evaluates these bits using the comparator.

The monitoring unit 38 may be analogously connected to the serial bus 36 and/or may also have a transceiver module 50 (for example, a UART).

FIG. 3 shows a flow chart for a method for checking the status of the field devices 26 of the building-based passenger transport system 10, which can be carried out by the communication system 34 and in particular the monitoring unit 38 and the field devices 26.

In step S10, the monitoring unit 38 determines the safety-relevant field devices 26 connected to the bus 36. The field devices and their bus addresses can for example be stored in a table of bus nodes in the monitoring unit 38. It is also possible for field devices 26 to register on the bus 36 or with the monitoring unit 38 via the bus 36.

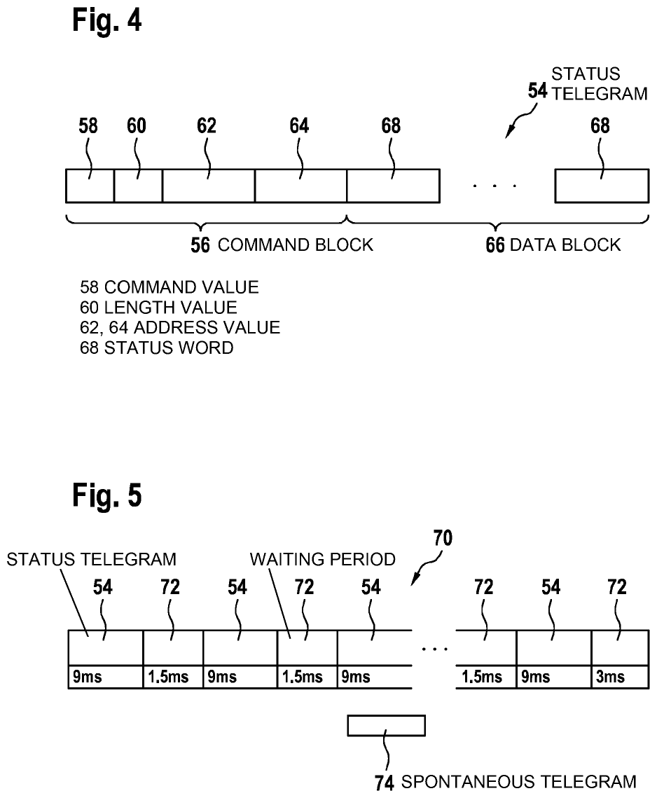

Furthermore, the monitoring unit 38 forms groups of field devices 26, which are intended to be addressed simultaneously with a status telegram 54, as shown for example in FIG. 4. In the following steps S12 to S16, a status telegram 54 is then generated and evaluated for each of the groups in one cycle.

In step S12, the monitoring unit 38 transmits, via the serial bus 36, a command block 56 of the status telegram 54 to the field devices 26 connected to the serial bus 36, which relates to a group of field devices 26 corresponding to the cycle.

In general, the status telegram 54 shown in FIG. 4 is divided into a command block 56 and a data block 66. In turn, the command block 56 is again divided into a command value 58, a length value 60 and two address values 62, 64 in this order. Other telegrams that are transmitted via the bus 36 may also have this structure. In contrast to the status telegram 54, these telegrams may also have a checksum.

The start of the command block 56 encodes a command value 58 which identifies the start of a status telegram 54. For example, the command value 58 may be 4 bits long.

It is possible for a status telegram 54 to be identified by two different command values 58, such as the binary numbers 0011 and 1100. The different command values may indicate that the remaining bits of status telegram 54 for the second command value 58 (such as 1100) and/or its data block 66 are inverted relative to the bits of a corresponding status telegram 54 with the first command value 58 (such as 0011) or its data block 66 having the same content. For example, the monitoring unit 38 can alternately transmit status telegrams with the first command value 58 and the second command value 58.

After the command value 58, the status telegram 54 can encode a length value 60 or a telegram length 60. This length value can, for example, represent the next 4 bits of the status telegram 54 and/or indicate how long the status telegram 54 is (in bytes).

The remainder of the command block 56 may be formed by two address values 62, 64. The address values may each have the length of one byte, i.e. 8 bits. For example, the address values 62, 64 encode a source address of the telegram and a destination address, as may be the case with all telegrams. For a status telegram 54, the address values 62, 64 can also encode the groups of field devices 26 which are to be addressed by the status telegram 54.

By way of example, the address value 62 may specify a first addressed field device 26 and the address value 64 may specify a last addressed field device 26 of an address interval. However, it is also possible for the destination address 64 to specify the first addressed field device 26. From the length value 60, the number of field devices 26 addressed by this status telegram 54 is then obtained. With a maximum length of the status telegram of 15 bytes, the data block 66 can contain a maximum of 12 data bytes.

In step S14, all the field devices 26 receive the command block 56 of the status telegram 54 and evaluate said block with the synchronization module 40. In particular, the command block 56 is received and decoded by the transceiver module 42. When a command value 58 for a status telegram 54 has been received, the elements 60, 62, 64 are forwarded to the transmission position determination module 44. Telegrams having other content are forwarded by the transceiver module 42 to the transceiver module 50.

When the transmission position determination module 44 of a field device 26 determines that the field device is addressed by the status telegram 54, it determines a status end position in the data block 66. The data block 66 may be divided into status words 68 of the same bit length (such as 8 bits, i.e. one byte), which are assigned to the addressed field devices 26. A status word may additionally contain start and stop bits. The status end position may then be determined, for example, by subtracting the address of the field device 26, which may be stored in the synchronization module 40, from the first destination address (which may be stored in the address value 64). If the result is greater than 0 and less than the length of the data block 66, the result is the status end position.

The transmission position determination module 44 then waits until the transmission position has been reached in the telegram. The time difference to the end of the command block 56 may be determined by multiplying the time unit for a bit by the bit length of a status word 68 and by the transmission position.

When the transmission position has been reached, the transmission position determination module 44 instructs the transceiver module 42 to transmit a status value of the field device 26 to the monitoring unit 38 via the serial bus 36.

The status value may encode the status of the field device 26 itself or the status of one or more of the safety sensors 28 that are connected to the corresponding field device 26. The status value may be stored in the synchronization module 40 and/or may be updated by the microcontroller 48 on a regular basis.

For each status word 68, an extended (8,4) Hamming code may be used. In this case, 4 data bits can be mapped via the 7,4 Hamming code generator matrix to 7-bit code words and extended by an additional parity bit in order to achieve a minimum Hamming distance of 4 (see, for example, https://en.wikipedia.org/wiki/Hamming7,4).

Subsequently, an XOR operation of the status value with the address of the field device 26 which transmits the status value can take place. Therefore, the monitoring unit 38 can check whether the status value comes from the expected field device 26 in which the expected address is applied to the status value by means of an XOR operation and a valid Hamming code results.

The encoding of the status value which is transmitted in the status word 68 can be carried out by the synchronization module 40 or by the microcontroller 48.

In step S16, the monitoring unit 38 receives the data block 66 supplemented by the addressed field devices 26 and evaluates the status values.

If the status telegrams 54 are generated regularly for a group of field devices, the monitoring unit 38 can determine the bits of the data block 66 of a status telegram 54 by means of a majority formation of bit values of a plurality of status telegrams 54 addressing the same field devices 26.

For example, the data blocks 66 of successive status telegrams 54 which relate to the same group of field devices 26 can be combined by means of majority formation.

It may also be the case that the majority formation takes place in a field-device-specific manner, i.e. the last received status words assigned to a field device 26 are combined in this way.

The majority formation of bits of the data block 66 and/or of a status word 68 can only take place if at least one status word 68 that has been encoded with error-indicating encoding indicates erroneous encoding.

For example, the consideration time window may be three cycles long. The validity of the information can be evaluated per status word 68, i.e. per field device 26. First, the error correction of the 8,4 Hamming code may be applied to each of the last-received status words 68. The most recent valid status word 68 can then be trusted. If none of the considered status words 68 from a field device 26 is valid, a substitute status word is formed over bitwise majority of the last three status words 68. If this is also invalid, an erroneous state of the field device 26 or the communication connection can be assumed.

In the case of a correct 8,4 Hamming code, the status value is determined and it is checked whether the corresponding field device 26 signals a safety-relevant issue.

In both cases, i.e. when the status values received by the monitoring unit 38 indicate a hazard detected by the safety sensors 28 connected to the field devices 26 or when the status values received and decoded by the monitoring unit 38 indicate erroneous encoding, the monitoring unit 38 generates an alarm. The alarm can be relayed to the central controller 22, which then stops the operation of the system 10, for example.

After step S16, the monitoring unit 38 may transmit the next status telegram 54 of a cycle. It should be noted that the steps S12 and S16 can also be carried out using corresponding hardware at least partially in parallel.

FIG. 5 shows a diagram for a query cycle 70, by means of which all the field devices 26 connected to the bus 36 can be queried once by means of a plurality of status telegrams 54. The field devices 26 are divided into groups which are each addressed by a status telegram 54 from the cycle 70. The query cycles 70 can be transmitted regularly.

A query cycle 70 is shown by means of which approximately 200 field devices 26 can be addressed in a cycle time of about 180 ms. In order to be able to address the 200 field devices 26, 17 status telegrams are transmitted in the query cycle 70, which can address 12 field devices 26 in each case.

Each of the status telegrams 54 may have a length of approximately 9 ms. A waiting period 72 is provided between the status telegrams 54, which may be approximately 1.5 ms. The waiting periods may be used by the field devices 26 or other bus participants to transmit their own telegrams. In FIG. 5, a spontaneous telegram 74 is shown by way of example for this purpose.

The monitoring unit can only wait for spontaneous telegrams 74 between the status telegrams. At the end of a query cycle 70, a longer waiting period 74 for normally prioritized telegrams may be provided.

In step S18 (see FIG. 3), a field device 26, when it detects a status change in a connected safety sensor 28, can start transmitting a spontaneous telegram 74 to the monitoring unit 38 within a waiting period 72, which encodes the status change.

A spontaneous telegram 74 can then be immediately decoded by the monitoring unit 38. If a spontaneous telegram 74 is transmitted, the monitoring unit 38 can interrupt the query cycle 70 being carried out.

It is possible for the monitoring unit 38 to confirm the receipt of the spontaneous telegram 74 with a further telegram to the transmitter of the spontaneous telegram 74. Even erroneous reception can be communicated by a corresponding telegram to the transmitter of the spontaneous telegram 74. If the transmitter of the spontaneous telegram 74 does not receive a confirmation telegram or a telegram about erroneous reception, the transmitter can repeat the transmission of the spontaneous telegram 74 in the next waiting period 72.

For example, to prevent two field devices 26 from simultaneously transmitting a spontaneous telegram 74, the collision detection module 46 of each field device 26 monitors the bus 36. For this purpose, the collision detection module 46 can monitor the bus at a sample rate which is substantially greater than the frequency of the bit values. For example, this sample rate may be greater than the bit frequency by at least a factor of 10.

If the collision detection module 46 detects that the bus 36 is already occupied before the start of an intended transmission, it can suppress the transmission. In this case, collisions can be completely avoided.

If transmission has already started, a collision can be detected by the field device 26, which sets the bus signal to “1” but instead detects “0” on the receiving side, i.e. after the comparator 53. In this case, the field device 26 that has detected the collision aborts its transmission and the bit of the other field device 26 is transmitted correctly.

Finally, it should be noted that terms such as “comprising,” “including,” etc. do not preclude other elements or steps, and terms such as “a” or “an” do not preclude a plurality. It must further be noted that features or steps which have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for checking a status of field devices of a building-based passenger transport system, the method comprising the steps of:
transmitting a command block of a status telegram from a monitoring unit via a serial bus to a plurality of field devices connected to the serial bus;
ones of the field devices addressed by the command block supplementing the status telegram wherein each of the addressed field devices receives the command block and determines a status end position in a data block of a status message adjoining the command block, each of the addressed field devices transmitting an associated status value to the monitoring unit via the serial bus when a status end position in the data block is reached, the status value encoding the status of the associated addressed field device;
receiving the data block supplemented by the addressed field devices with the monitoring unit;
evaluating the status values using the monitoring unit; and
controlling operation of the passenger transport system with a central control unit that responds to the evaluated status values.

17. The method according to claim 16 wherein the command block includes an encoded command value that identifies a start of the status telegram.

18. The method according to claim 17 wherein the encoded command value can have different first and second command values, and wherein the first command value indicates that remaining bits of the status telegram and/or the data block thereof are inverted relative to same content remaining bits and/or the data block of the status telegram having the second command value.

19. The method according to claim 16 wherein the command block includes encoded destination addresses that determine which of the field devices are addressed by the status telegram.

20. The method according to claim 16 wherein the command block includes an encoded length value of the status telegram.

21. The method according to claim 16 wherein the data block is divided into status words of a same bit length, the status words being assigned to associated ones of the addressed field devices and in which the status value of the assigned associated field device is coded, and wherein the status end position is a start of the status word assigned to the associated field device.

22. The method according to claim 16 further comprising generating an alarm if the status values received by the monitoring unit indicate a hazard detected by a switch or a security sensor connected to any of the addressed field devices.

23. The method according to claim 16 wherein the status values are encoded with at least one of an error-indicating encoding, and error-correcting encoding and a Hamming encoding.

24. The method according to claim 16 further comprising generating an alarm if the status values received and decoded by the monitoring unit indicate erroneous encoding.

25. The method according to claim 16 wherein all of the field devices connected to the bus are addressed by a plurality of status telegrams regularly transmitted in a cycle, and wherein the field devices are divided into groups, each of the groups being addressed by one of the status telegrams in the cycle.

26. The method according to claim 16 wherein the status telegram is generated regularly, and wherein the monitoring unit determines bits of the data block of the status telegram by a majority formation of bit values of a plurality of the status telegram addressing the associated field devices.

27. The method according to claim 26 wherein the majority formation of bit values of the data block takes place only if at least one status word in the data block that has been coded with error-indicating encoding indicates erroneous encoding.

28. The method according to claim 16 wherein at least two of the status telegram occupy the bus at a predetermined time interval and waiting periods are provided between the status telegrams, and wherein when one of the field devices detects a status change in a connected safety sensor, the one field device starts transmitting a spontaneous telegram to the monitoring unit via the serial bus within the waiting period, the spontaneous telegram including the status change encoded.

29. A communication system for a building-based passenger transport system, the communication system comprising:
a plurality of field devices;
a monitoring unit;
a serial bus connected to the monitoring unit and to the field devices; and
wherein the communication system adapted to perform the method according to claim 16.

30. The communication system according to claim 29 wherein each of the field devices includes a synchronization module that comprises a transceiver module and a transmission position determination module, wherein the transceiver module transmits and receives bit sequences via the serial bus and is adapted to recognize the command block of the status telegram and to transmit status values within the status telegram, and wherein the transmission position determination module is adapted to determine the status end position from the command block of the status telegram received with the transceiver module and to thus trigger the transceiver module to transmit the status value.
